(19) United States
(12) Patent Application Publication
(10) Pub. No.: US 2001/0001643 A1
(43) Pub. Date: May 24, 2001

(54) MODULAR SOLID PHASE EXTRACTION PLATE ASSEMBLY

(75) Inventors: NIGEL SIMPSON, TORRANCE, CA (US); DAVID R. NAU, MANHATTAN BEACH, CA (US); ALBERT J. BUFFA, WINNETKA, CA (US)

Correspondence Address: Varian Inc., Legal Department, 3120 Hansen Way D-102, Palo Alto, CA, 94304, US

(73) Assignee: Nigel Simpson

(21) Appl. No.: 09/208,610

(22) Filed: Dec. 8, 1998

(51) Int. Cl. B01D 24/00; B01D 27/00

(52) U.S. Cl. 422/101; 422/102; 210/348; 210/322; 210/634; 211/74; 29/890.09; 29/453; 29/466

(57) ABSTRACT

A 96-well solid phase extraction (SPE) plate assembly comprises a common base plate having plural apertures (bores), and removable extraction cartridges (containers, tubes) extending through the bores. The plate assembly is mounted on a conventional 96-well plate vacuum manifold. The cartridges preferably snap into the base plate, but may also screw in. The apertures have annular counterapertures (counterbores) complementary to annular ridges protruding from the side walls of the cartridges. Each ridge snaps into a corresponding counteraperture. The modular design allows the end user to customize the extraction medium mix of the extraction plate assembly by inserting extraction containers having different sorbents into a common base plate. Gaskets are used to maintain a vacuum seal between the base plate and extraction cartridges, for maintaining a pressure gradient across the sorbents.

### FIELD OF INVENTION

This invention relates to systems and methods for extracting solutes from solutions, and in particular to components and methods for solid phase extraction (SPE).

### BACKGROUND OF THE INVENTION

In conventional solid phase extraction methods, solutes of interest are isolated from solution by running the solution through a solid phase extraction medium (sorbent) such as coated silica particles. A 96-well solid phase extraction plate is typically placed on a vacuum manifold. The vacuum manifold provides a pressure gradient over sorbents in the plate wells, driving the flow of liquid through the wells. The solutes of interest bind to the extraction medium, while the rest of the solution passes on to collection containers. The solutes of interest can then be recovered by running a suitable solvent through the extraction medium.

Typical extraction plates are monolithic 96-well plates having identical sorbents in all their wells. For descriptions of such plates see for example U.S. Pat. Nos. 5,417,923, 5,047,215, 5,679,310, and European Patent Publication No. 0576602B1. The end user of a conventional monolithic plate cannot customize the sorbents in different wells of the plate in a practical manner. Thus, an end user investigating different assay methodologies and sorbents for a particular application may need a new 96-well extraction plate for each tested condition, even if only a few wells are required.

### SUMMARY OF THE INVENTION

The present invention provides an extraction apparatus comprising a vacuum manifold connected to a vacuum source, defining a collection enclosure; a plurality of collection containers disposed in the collection enclosure; and an extraction plate assembly mounted on the manifold and covering the collection enclosure. The extraction plate assembly comprises a base plate mounted on the manifold, and a plurality of extraction cartridges mounted on the base plate.

The base plate has a top surface and a bottom surface. A plurality of apertures extend through the base plate from the top surface to the bottom surface. Each extraction cartridge has an inlet and an outlet. Each cartridge is removably locked in a corresponding aperture of the base plate with its inlet situated opposite its outlet relative to the base plate. Locking the extraction cartridges to the base plate allows the end user to reuse the base plate, replace used extraction cartridges, and customize the extraction media of the extraction plate assembly. Reusing the base plate allows the end user to reduce the amount of material discarded with each use.

Each cartridge comprises a solid-phase extraction medium disposed between its inlet and its outlet, for extracting solutes of interest from a liquid sample inserted into the cartridge through its inlet. Different cartridges of the extraction plate assembly may have different extraction media. Each base plate aperture and cartridge outlet faces a corresponding collection container when the extraction plate assembly is mounted on the manifold, such that the collection container receives liquid from the cartridge outlet.

Each cartridge is preferably locked to the base plate through a snap-in lock. A snap-in lock allows relatively easy insertion and removal of cartridges from the base plate, and allows multiple linked cartridges to be removed from or inserted into the base plate simultaneously, in one motion. Preferably, the base plate has a counteraperture defined in the side wall of each aperture, and each extraction cartridge has a snap-in ridge for engaging a corresponding counteraperture to snap the cartridge into the base plate. Alternatively, each aperture may have a ridge defined in its side wall, and each cartridge may have a corresponding complementary depression for engaging the ridge.

The counteraperture is preferably situated at the bottom end of its corresponding aperture, along the bottom surface of the base plate, such that the snap-in ridge is positioned along the bottom surface when the cartridge is locked to the base plate. The counteraperture may also be situated within its corresponding aperture, such that the snap-in ridge is enclosed within the aperture when the extraction cartridge is locked to the base plate. Positioning the counteraperture at a base plate edge allows relatively close spacings between adjacent apertures, by relaxing the constraints imposed on the minimum inter-counteraperture spacing by base plate mechanical stability requirements. Closely spacing adjacent apertures allows increased cartridge fluid-holding volumes as a fraction of the total volume defined by the overall dimensions of the extraction plate assembly.

In an alternative embodiment, each cartridge is locked to the base plate through a screw-in lock. The base plate then has a helical groove defined in each aperture, and each cartridge has a helical thread complementary to the groove, for engaging the groove to screw the cartridge into the base plate.

The extraction plate assembly does not allow any substantial air paths therethrough other than through the extraction media. If the seal provided by the locking interface is not sufficient, a gasket may be used to establish a vacuum seal along an interface between each cartridge and the base plate. The gasket is preferably positioned between the top surface of the base plate and a lip of the cartridge. The gasket prevents gas flow through its corresponding base plate aperture, outside the cartridge.

The present invention further provides a method of making an extraction plate assembly and an extraction apparatus of the present invention. The base plate and extraction cartridges are individually manufactured by injection molding, extrusion, or other known techniques. The extraction cartridges are then locked into the base plate. The resulting extraction plate assembly if mounted onto the manifold, and positioned underneath a fluid-handling apparatus.

### BRIEF DESCRIPTION OF THE DRAWINGS

FIG. 1-A shows a perspective view of a preferred extraction apparatus of the present invention.

FIG. 1-B shows a side sectional view of the apparatus of FIG. 1-A.

FIG. 1-C shows a top view of the apparatus of FIG. 1-A.

FIG. 2-A shows a side sectional view of two extraction containers locked in a base plate, according to the preferred embodiment of the present invention.

FIG. 2-B shows a top view of one of the extraction containers of FIG. 2-A.

FIGS. 3-A through 3-E illustrate side sectional views of extraction containers locked in base plates, according to respective alternative embodiments of the present invention.

### DETAILED DESCRIPTION OF THE INVENTION

In the following description, the term “vacuum” is understood to encompass partial vacuum pressures. The terms “top” and “bottom” are understood to be relative terms characterizing spatial relationships relative to a major plane of a base plate; the terms need not refer to the direction of gravity.

The following description illustrates embodiments of the invention by way of example and not necessarily by way of limitation.

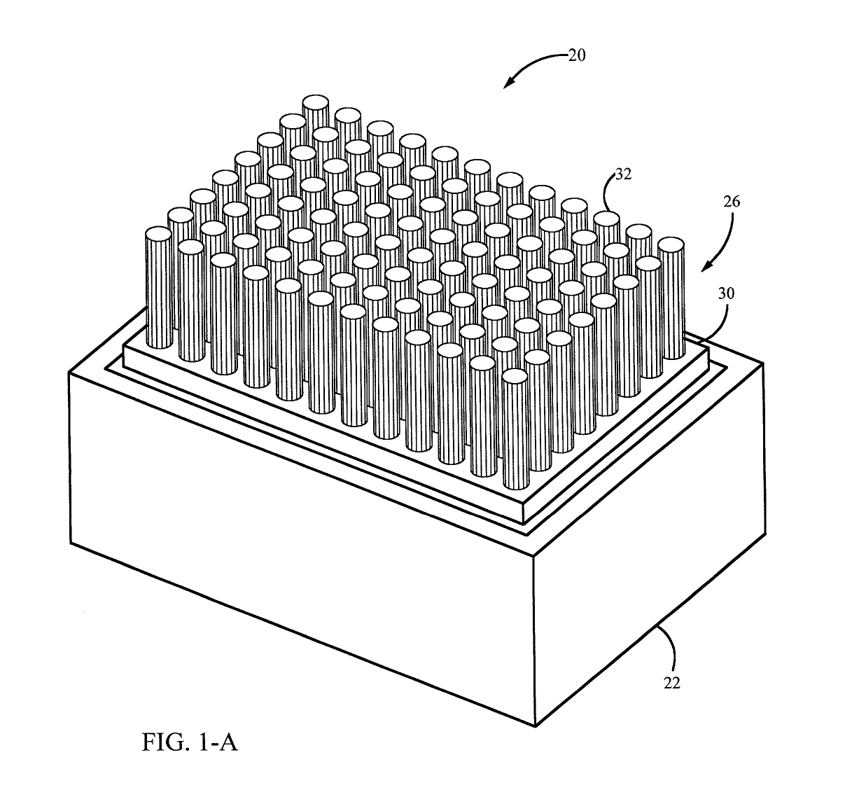

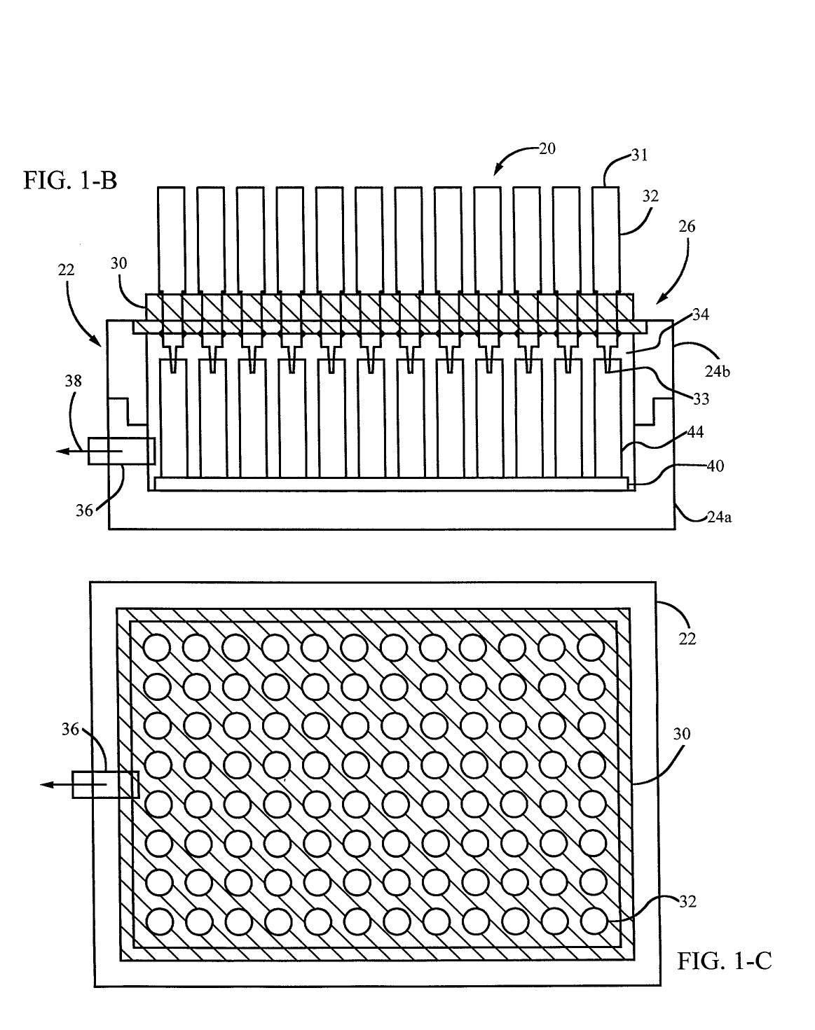

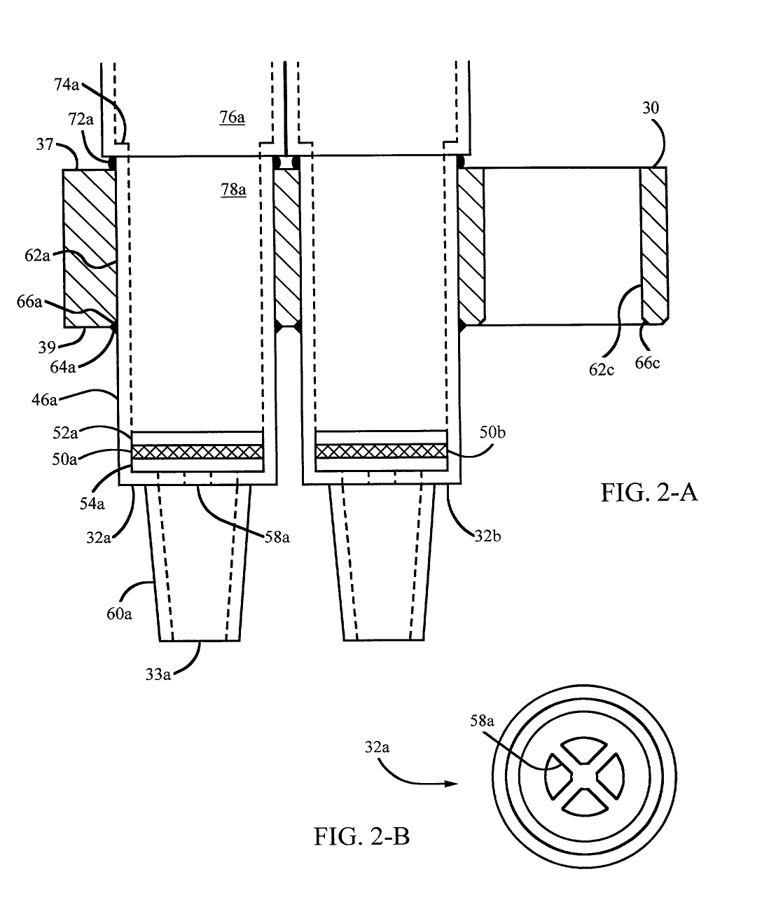

FIG. 1-A shows a perspective view of a preferred extraction apparatus 20 of the present invention. FIGS. 1-B and 1-C show side sectional and top views of apparatus 20, respectively. Apparatus 20 comprises a vacuum manifold 22, and an extraction plate assembly 26 mounted on manifold 22. Extraction plate assembly 26 comprises a base plate 30 mounted on manifold 22, and a plurality of extraction cartridges (containers, tubes) 32 mounted on base plate 30. Cartridges 32 are locked into base plate 30, allowing an end user to replace selected cartridges 32 and reuse base plate 30. Base plate 30 is hatched in FIGS. 1-B and 1-C for clarity of presentation. Extraction plate assembly 26 preferably comprises 96 extraction cartridges 32, each passing through an aperture in base plate 30.

As illustrated in FIG. 1-B, each extraction cartridge 32 has an inlet 31 and an outlet 33. Each cartridge 32 further comprises a conventional extraction solid phase extraction medium (not shown) positioned in the fluid path between inlet 31 and outlet 33. When cartridge 32 is mounted on base plate 30, inlet 31 and outlet 33 are situated on opposite sides of base plate 30. Inlet 31 is formed by an opening at the top of cartridge 32, above base plate 30. Outlet 33 is formed by a spout at the bottom of cartridge 32, underneath base plate 30. A conventional robotic sample-handling apparatus (not shown) is positioned to insert a sample through inlet 31. The sample-handling apparatus may constrain the height of extraction apparatus 20 and cartridges 32.

Manifold 22 may be a conventional vacuum manifold for holding 96-well collection plates. Manifold 22 comprises a manifold base 24a, and a support part 24b mounted on manifold base 24a. An air conduit 36 is formed in one of the side walls of manifold base 24a, for connecting the interior of manifold 22 to a conventional vacuum source such as a vacuum pump (not shown). The direction of air flow through air conduit 36 is illustrated by the arrow 38.

Support part 24b has a rectangular top aperture for receiving base plate 30. Base plate 30 is mounted on support part 24b. Manifold 22 and extraction plate assembly 26 define a sealed enclosure 34 which is externally connected only through air conduit 36 and extraction containers 32, as explained in more detail below. Gaskets (not shown) may be provided at the interfaces between manifold base 24a and support part 24b, and between support part 24b and base plate 30, for sealing enclosure 34.

A collection plate 40 is positioned in manifold 22, within enclosure 34. Collection plate 40 can be a standard 96-well collection plate. Collection plate 40 comprises a plurality of collection containers 44 each positioned facing a corresponding aperture of base plate 30 and a corresponding outlet 33. Each collection container 44 is positioned to receive liquid that has passed through a corresponding extraction cartridge 32.

The vacuum pump connected to air conduit 36 establishes a partial vacuum within enclosure 34. Liquid samples each comprising multiple solutes are inserted into inlets 31 by a conventional automatic pipetter (not shown). The pressure gradient across extraction cartridges 32 draws the samples through cartridges 32. The extraction media within cartridges 32 capture solutes of interest from the samples, while the remaining solutes and solvent are transferred to collection containers 44 through outlets 33. The solutes of interest can then be eluted from cartridges 32.

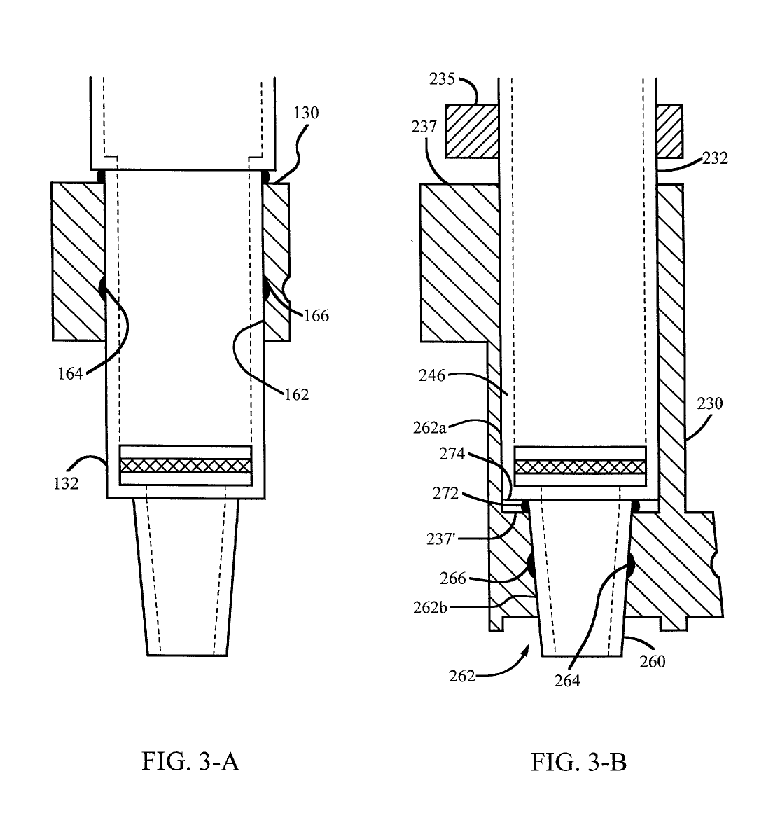

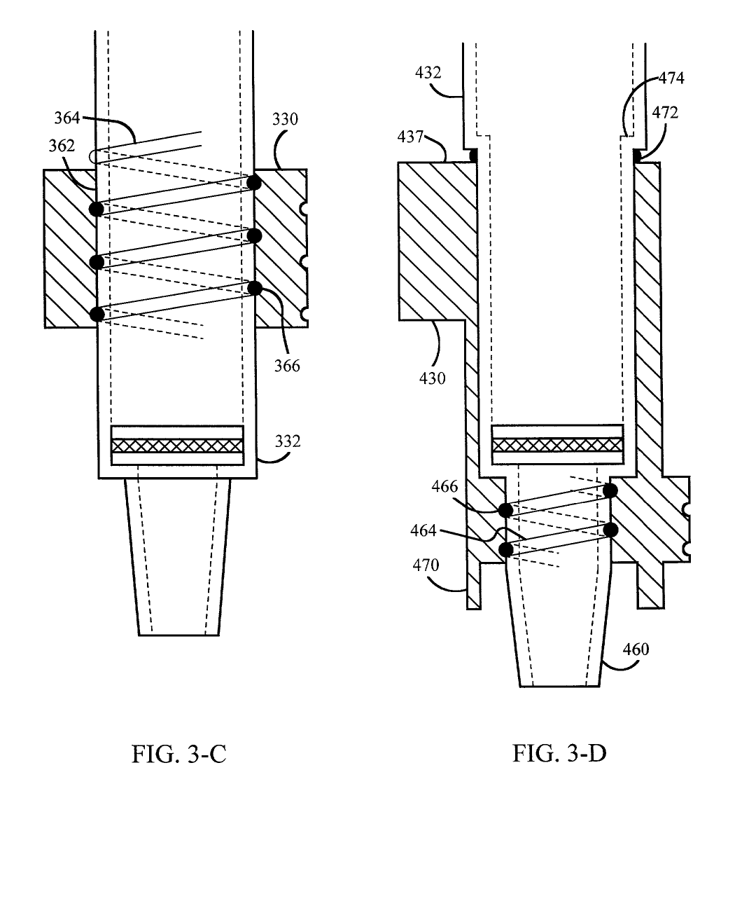

FIG. 2-A shows a more detailed side sectional view of part of extraction plate assembly 26, illustrating part of two extraction cartridges 32a-b and base plate 30. FIG. 2-B shows a top view of extraction cartridge 32a. Cartridge 32b is similar to cartridge 32a. As illustrated in FIG. 2-A, cartridge 32a comprises a generally cylindrical fluid-holding body 46a, and a tapered outlet spout 60a extending downward from fluid-holding body 46a. A disk-shaped or cylindrical solid-phase extraction medium 50a is positioned in the fluid passage of cartridge 32a, at the bottom of fluid-holding body 46a. Extraction medium 50a is a conventional solid phase extraction (SPE) silica- or polymer-based sorbent. Suitable surface functional groups for the sorbent include cyano, C1, C2, C4, C8, C18, cyclohexyl, phenyl, among others. Extraction medium 50a is sandwiched between two conventional frit disks 52a, 54a. Extraction medium 50a may be different from the extraction medium 50b of cartridge 32b.

The frit-sorbent composite formed by frit disks 52a, 54a and extraction medium 50a is pressed against the inside side wall of cartridge 32. Extraction medium 50a and frit disks 52a, 54a are supported by a support structure 58a extending into the fluid passage of cartridge 32a, as illustrated in FIG. 2-B. The transverse cross-section of support structure 58a is preferably cross-shaped. Support structure 58a prevents the frit-sorbent composite from sagging into outlet spout 60a as liquid passes through cartridge 32a.

As illustrated in FIG. 2-A, cartridge 32a is slidably mounted on base plate 30 through an aperture 62a. Aperture 62a extends through base plate 30 from a top surface 37 to a bottom surface 39 of base plate 30. Top surface 37 and bottom surface 39 are preferably substantially planar, parallel surfaces, but may generally include recessed or protruding sections. Aperture 62a is preferably a cylindrical bore having an inside diameter substantially equal to the outside diameter of the part of cartridge 32a within aperture 62a. Aperture 62a may generally have a non-circular cross-section, such as a square, rectangular, or oval cross-section.

Aperture 62a has an annular counteraperture (depression, recess) 66a defined at the bottom end of its side wall, along bottom surface 39 of base plate 30. Counteraperture 66a lies in a plane perpendicular to the longitudinal axis of aperture 62a. Cartridge 32a has a snap-in ridge 64a protruding from its side wall. Ridge 64a is complementary to counteraperture 66a. At least part of the surface of ridge 64a engages counteraperture 66a to snap-in cartridge 32a into base plate 30. Ridge 64a preferably has a triangular longitudinal cross-section. The top planar surface of ridge 64a abuts counteraperture 66a, facilitating the locking and removal of cartridge 32a. The bottom planar surface of ridge 64a facilitates the insertion of cartridge 32a into aperture 62a. A free counteraperture 66c is shown for an aperture 62c in the absence of a corresponding extraction cartridge.

A PTFE (teflon) or rubber gasket 72a is positioned between top surface 37 and a lip 74a of cartridge 32a. Gasket 72a may be provided as part of base plate 30, and may be attached to base plate 30 by an adhesive. Gasket 72a may also be provided as part of cartridge 32a. Gasket 72a prevents gas flow through aperture 62a outside cartridge 32a, between the side walls of aperture 62a and cartridge 32a. Gasket 72a establishes a vacuum seal along the interface between cartridge 32a and base plate 30, ensuring that the pressure gradient across base plate 30 efficiently drives the flow of fluid through cartridge 32a. Lip 74a is preferably defined by the interface between an upper section 76a and a lower section 78a of fluid holding body 46a. Upper section 76a has a larger transverse size than lower section 78a.

Extraction cartridge 32a is preferably made of a plastic such as polypropylene. Other suitable materials for cartridge 32a include polyethylene or PTFE. Cartridge 32a is preferably made by injection molding. Other suitable methods for forming cartridge 32a include extrusion or machining.

For a 96-well extraction plate assembly, cartridge 32a has a fluid-holding volume on the order of a few ml, typically between 1 ml and 5 ml, preferably about 2 ml. The center-to-center spacing between adjacent cartridges 32 on base plate 30 is on the order of mm to cm, preferably about 9 mm. The side wall of cartridge 32a preferably has a constant thickness on the order of tenths of mm to mm, preferably about 0.5 mm. Upper section 76a of fluid holding body 46a has a length on the order of a few cm, preferably about 38 mm, an outside diameter on the order of mm, preferably about 9 mm, and an inside diameter on the order of mm, preferably about 8 mm. Lower section 78a of fluid holding body 46a has a length on the order of cm, preferably about 17 mm, an outside diameter on the order of mm, preferably about 8 mm, and an inside diameter on the order of mm, preferably about 7 mm. The diameter of aperture 62a is equal to the outside diameter of lower section 78a.

The distance between lip 74a and the center of ridge 64a is on the order of mm to cm, preferably about 6.5 mm. Ridge 64a has a longitudinal dimension of about 1 mm. The sum of the thickness of gasket 72a and the distance between upper surface 37 and lower surface 39 of base plate 30 is about equal to the distance between lip 74a and the center of ridge 64a. Ridge 64a protrudes about 0.25 mm from the side wall of cartridge 32a. Counteraperture 66a preferably has a depth of about 0.35 mm, and forms angles of about 45° with respect to the side wall of aperture 62a and with bottom surface 39 of base plate 30. The extent of base plate 30 between cartridges 32a-b is preferably about 1 mm along aperture 62a, and at least 0.3 mm at the bottom of counteraperture 66a.

The snap-in attachment of cartridges 32 to base plate 30 allows easy assembly of a heterogeneous extraction plate assembly 26 from cartridges having different extraction media. An end user may obtain extraction cartridges 32 separately from base plate 30, and then choose the distribution of extraction media to use for extraction plate assembly 26. A heterogeneous extraction plate assembly allows easily testing multiple extraction media simultaneously, thus facilitating method development, optimization studies, and comparisons or different extraction media. Furthermore, the end user may reuse base plate 30 with new cartridges 32, or use base plate 30 with only a subset of its potential cartridges 32 by stoppering the unused apertures. By contrast, an end user constrained to use prior-art monolithic extraction plates would need a large number of different extraction plates for testing different extraction media. The end user may need a means of identifying used wells in the monolithic plate, or may need to discard an entire monolithic plate after each use even if a large number of wells within each monolithic plate are not needed for a particular testing method.

Placing counteraperture 66a along an external surface of base plate 30 allows reducing the spacing between adjacent cartridges 32. A counteraperture internal to the base plate may require larger spacings between adjacent cartridges, since the base plate internal side walls between adjacent counterapertures need to provide sufficient mechanical stability to the base plate. That is, mechanical stability concerns may require larger inter-counteraperture spacings for internal counterapertures than for external counterapertures.

Placing counteraperture 66a along bottom surface 39 and gasket 72a along top surface 37 allows easy insertion of cartridge 32a from the top of base plate 30. The transverse cross-sections of cartridge 32a, aperture 62a, and counteraperture 66a are preferably circular for ease of manufacture of cartridge 32a and base plate 30, and for ease of insertion of cartridge 32a into base plate 30. A flat contact surface for the interface between ridge 64a and counteraperture 66a is preferred for ease of manufacture of cartridge 32a and base plate 30. Defining counteraperture 66a in base plate 30 and ridge 64a on cartridge 32 may allow the use of fewer mold parts during the manufacture of cartridge 32 than defining a ridge in the base plate and a complementary depression in the cartridge.

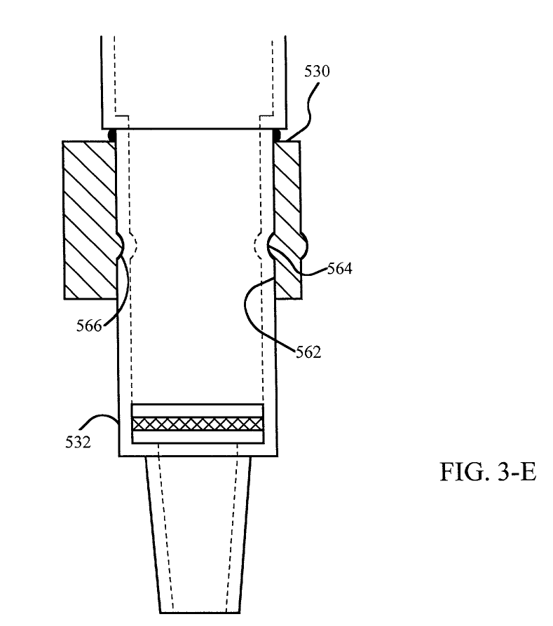

FIG. 3-A shows a side sectional view of part of an extraction cartridge 132 and a corresponding base plate 130, according to an alternative embodiment of the present invention. Base plate 130 has an annular counteraperture 166 which is internal to its corresponding aperture 162. In longitudinal cross-section (in the plane of FIG. 3-A), counteraperture 166 has a curved shape. Cartridge 132 has an annular ridge 164 complementary to counteraperture 166. The curved surface of the interface between ridge 164 and counteraperture 166 allows an improved fit between cartridge 132 and base plate 130.

FIG. 3-B shows a side sectional view of part of an extraction cartridge 232 and a base plate 230, according to another alternative embodiment of the present invention. Base plate 230 comprises an aperture 262 extending therethrough. Aperture 262 comprises an upper section 262a and a lower section 262b. Upper section 262a has a larger diameter than lower section 262b. A counteraperture 266 is defined in lower section 262b. Base plate 230 has a top surface 237 including a recessed portion 237′.

Cartridge 232 comprises a fluid-holding body 246 and an outlet spout 260 extending downward from fluid-holding body 246. Fluid holding body 246 defines a lip 274 at its interface with outlet spout 260. Cartridge 232 further comprises a ridge 264 protruding from outlet spout 264. Ridge 264 is complementary to counteraperture 266, and engages counteraperture 266 to lock cartridge 232 to base plate 230. A gasket 272 is sandwiched between lip 274 and recessed portion 237′, sealing aperture 262 and preventing air flow outside cartridge 232.

Cartridge 232 is part of a monolithic group of cartridges connected by a connection plate 235. The cartridge group may be for example a strip of 8 or 12 cartridges having identical extraction media. The cartridge group may be collectively locked to and removed from base plate 230. The cartridge group and connection plate 235 may be formed by an individual molded piece.

FIG. 3-C shows a side sectional view of part of an extraction cartridge 332 and a corresponding base plate 330, according to yet another alternative embodiment of the present invention. Base plate 330 has an aperture 362 extending therethrough. A helical groove 366 is defined in aperture 362. Helical groove 366 extends through aperture 362. Cartridge 364 has a helical thread 364 protruding from its side wall. Helical thread 364 is complementary to helical groove 366, and engages helical groove 366 to screw cartridge 332 into plate 330.

FIG. 3-D shows a side sectional view of part of an extraction cartridge 432 and a corresponding base plate 430, according to still another alternative embodiment of the present invention. Cartridge 432 has a helical thread 464 protruding from an outlet spout 460. Helical thread 464 engages a complementary helical groove 466 defined in a lower section 462b of an aperture 462. Outlet spout 460 extends through lower section 462b. A fluid-holding body 446 of cartridge 432 extends through an upper section 462a of aperture 462. A gasket 472 rests on base plate 430 at the upper end of upper section 462. A lip 474 of cartridge 432 is pressed down onto gasket 472.

FIG. 3-E shows a side sectional view of a part of an extraction cartridge 532 and a corresponding base plate 530, according to yet another alternative embodiment of the present invention. Base plate 530 has an aperture 562 for receiving cartridge 532. A ridge 564 protrudes from the side wall of aperture 562. Cartridge 532 has an annular depression (recess, notch) 566 defined in its side wall, for engaging ridge 564 to snap cartridge 532 into base plate 530.

It will be clear to one skilled in the art that the above embodiments may be altered in many ways without departing from the scope of the invention. For example, the base plate need not be a monolithic molded part, but may include two or more sandwiched flat sections. More than one counteraperture may be used. Various approaches may be suitable for locking the extraction cartridges to the base plate and providing a vacuum seal between the cartridges and the base plate, including for example press-fitting each cartridge into a corresponding tapered aperture in the base plate. Positive pressure may be used to drive the samples through the extraction cartridges, by connecting each cartridge through an individual tube to a positive pressure source. Accordingly, the scope of the invention should be determined by the following claims and their legal equivalents.

What is claimed is:

1. An extraction plate assembly for extracting solutes from liquid samples, comprising:
a) a base plate having a top surface and a bottom surface, and a plurality of apertures extending through said base plate from said top surface to said bottom surface, each of said apertures having a counteraperture defined therein; and
b) a plurality of snap-in extraction cartridges each having an inlet and an outlet, each of said cartridges being slidably mounted in a corresponding aperture of said base plate with said inlet situated opposite said outlet relative to said base plate, said each of said cartridges having:
a snap-in ridge for engaging a corresponding counteraperture to snap said each of said cartridges into said base plate, and
a solid phase extraction medium disposed between said inlet and said outlet, for extracting a solute from a liquid sample inserted into said each of said cartridges through said inlet.

2. The plate assembly of claim 1 wherein said corresponding counteraperture is situated substantially at a bottom end of said corresponding aperture, along said bottom surface of said base plate, such that said snap-in ridge is positioned along said bottom surface of said base plate when said each of said cartridges is locked to said base plate.

3. The plate assembly of claim 1 wherein said corresponding counteraperture is situated within said corresponding aperture, such that said snap-in ridge is enclosed within said corresponding aperture when said each of said extraction cartridges is locked to said base plate.

4. The plate assembly of claim 1 further comprising a gasket positioned between said top surface and a lip of said each of said cartridges, for preventing gas flow through said corresponding aperture outside said each of said cartridges.

5. The plate assembly of claim 1 wherein said plurality of cartridges comprises a first cartridge having a first solid phase extraction medium, and a second cartridge having a second solid phase extraction medium different from said first solid phase extraction medium.

6. An extraction plate assembly for extracting solutes from liquid samples, comprising:
a) a base plate having a top surface and a bottom surface, and a plurality of apertures extending through said base plate from said top surface to said bottom surface; and
b) a plurality of extraction cartridges each having an inlet and an outlet, each of said cartridges being removably locked in a corresponding aperture of said base plate with said inlet situated opposite said outlet relative to said base plate, said each of said cartridges having a solid phase extraction medium disposed between said inlet and said outlet, for extracting a solute from a liquid sample inserted into said each of said cartridges through said inlet.

7. The plate assembly of claim 6 wherein:
a) said corresponding aperture has a counteraperture defined therein; and
b) said each of said cartridges has a snap-in ridge for engaging said counteraperture to snap said each of said cartridges into said base plate.

8. The plate assembly of claim 6 wherein:
a) said corresponding aperture has a helical groove defined therein; and
b) said each of said cartridges has a helical thread for engaging said groove to screw said each of said cartridges into said base plate.

9. The plate assembly of claim 6 wherein:
a) said corresponding aperture has a ridge protruding therefrom; and
b) said each of said cartridges has a depression for engaging said ridge to snap said each of said cartridges into said base plate.

10. The plate assembly of claim 6 further comprising a gasket positioned between said top surface and a lip of said each of said cartridges, for preventing gas flow through said corresponding aperture outside said each of said cartridges.

11. An extraction apparatus for extracting solutes from liquid samples, comprising:
a) a vacuum manifold connected to a vacuum source, defining a collection enclosure;
b) a plurality of collection containers disposed in said collection enclosure;
c) a base plate mounted on said vacuum manifold and covering said collection enclosure, said base plate having a top surface, a bottom surface, and a plurality of apertures extending through said base plate from said top surface to said bottom surface, each of said apertures being disposed substantially opposite one of said collection containers; and
d) a plurality of extraction cartridges each having an inlet and an outlet, each of said cartridges being removably locked in a corresponding aperture of said base plate with said inlet situated opposite said outlet relative to said base plate and with said outlet facing a corresponding collection container, said each of said cartridges comprising a solid phase extraction medium disposed between said inlet and said outlet, for extracting a solute from a liquid sample inserted into said each of said cartridges through said inlet.

12. The apparatus of claim 11 wherein:
a) said corresponding aperture has a counteraperture defined therein; and
b) said each of said cartridges has a snap-in ridge for engaging said counteraperture to snap said each of said cartridges into said base plate.

13. The apparatus of claim 12 wherein said counteraperture is situated substantially at a bottom end of said corresponding aperture, along said bottom surface of said base plate, such that said snap-in ridge is positioned along said bottom surface of said base plate when said each of said cartridges is locked to said base plate.

14. The apparatus of claim 12 wherein said counteraperture is situated within said corresponding aperture, such that said snap-in ridge is enclosed within said corresponding aperture when said each of said extraction cartridges is locked to said base plate.

15. The apparatus of claim 12 further comprising a gasket positioned between said top surface and a lip of said each of said cartridges, for preventing gas flow through said corresponding aperture outside said each of said cartridges.

16. The apparatus of claim 12 wherein said plurality of cartridges comprises a first cartridge having a first solid phase extraction medium, and a second cartridge having a second solid phase extraction medium different from said first solid phase extraction medium.

17. The apparatus of claim 10 wherein
a) said corresponding aperture has a helical groove defined therein; and
b) said each of said cartridges has a helical thread for engaging said groove to screw said each of said cartridges into said base plate.

18. The apparatus of claim 10 further comprising a gasket positioned between said top surface and a lip of said each of said cartridges, for preventing gas flow through said corresponding aperture outside said each of said cartridges.

19. A method of making an extraction plate assembly for extracting solutes from liquid samples, comprising:
a) providing a base plate having a top surface and a bottom surface, and a plurality of apertures extending through said base plate from said top surface to said bottom surface; and
b) providing a plurality of extraction cartridges each having an inlet and an outlet, each of said cartridges having a solid phase extraction medium disposed between said inlet and said outlet, for extracting a solute from a liquid sample inserted into said each of said cartridges through said inlet; and
c) locking each of said cartridges into a corresponding aperture of said base plate with said inlet situated opposite said outlet relative to said base plate.

20. The method of claim 19 wherein said locking said each of said cartridges comprises snapping-in said each of said cartridges into said corresponding aperture.
